(19) United States
(12) Patent Application Publication
(10) Pub. No.: US 2004/0045431 A1
(43) Pub. Date: Mar. 11, 2004

(54) Roller bearing, piston pump and pump unit

(76) Inventors: Edgar Schmitt, Vaihingen (DE); Heinz Siegel, Stuttgart (DE); Ernst-Dieter Schaefer, Brackenheim (DE); Erwin Sinnl, Meimsheim (DE)

Correspondence Address: Ronald E Greigg, Greigg & Greigg, Unit One, 1423 Powhatan Street, Alexandria, VA, 22314, US

(21) Appl. No.: 10/276,688

(22) PCT Filed: May 11, 2001
(86) PCT No.: PCT/DE01/01795

(30) Foreign Application Priority Data
May 16, 2000 (DE) 100 23 947.1

(51) Int. Cl. F16J 1/10

(52) U.S. Cl. 92/129

(57) ABSTRACT

The invention relates to a roller bearing, in particular a needle bearing (38). The invention proposes embodying a bearing ring (42) of the needle bearing (38) with a lateral extension (46) with which the needle bearing (38) can be pressed into a bearing seat (48). This has the advantage that a compression of the bearing ring (42) by the bearing seat (48) takes place outside the region of the needles (40) of the needle bearing (38) and consequently, the compression of the bearing seat (48) does not influence a bearing play of the needle bearing (38). The needle bearing (38) is particularly provided for supporting a shaft (24) of a piston pump (16) of a pump unit (10), which shaft supports a cam (26).

### PRIOR ART

The invention relates to a roller bearing that is particularly provided for rotatably supporting a cam of a piston pump, and also relates to a piston pump and pump unit, as generically defined by the preamble to claims 1, 8, and 10. The piston pump and the pump unit are particularly provided for use in slip-controlled hydraulic vehicle brake systems.

A pump unit of this kind with an electric motor as the pump motor for driving a piston pump is known from DE 44 30 909 A1. The piston pump has a pump housing, in which a cam is rotatably supported. A rotary drive of the cam drives a pump piston, which is contained so that it can move in the pump housing to execute a stroke motion. In a manner that is intrinsically known from piston pumps, the stroke motion of the pump piston produces a delivery of fluid.

In the known piston pump, the cam is supported so that it can rotate in the pump housing by means of a ball bearing, wherein an outer bearing ring of the ball bearing is pressed into a bearing seat in the pump housing. Due to cost and space considerations, the ball bearing should be replaced by a needle bearing. The compression of the bearing ring in the bearing seat of the pump housing produces a reduction of a diameter of the bearing ring. Since the compression can vary from piston pump to piston pump due to tolerances not only of the bearing seat in the pump housing, but also of the bearing ring, this changes a bearing play of the bearing. A diameter tolerance of a shaft of the cam also influences the bearing play. The greatest possible play due to the tolerances leads to a distinctly noticeable and unacceptable running noise of the bearing. With the least possible bearing play, the needles of the bearing can become jammed between the bearing ring and the shaft of the cam, which causes the bearing to wear prematurely.

### ADVANTAGES OF THE INVENTION

In the roller bearing according to the invention, with the characterizing features of claim 1, the bearing ring has a lateral extension with which the bearing can be pressed into a bearing seat. The compression of the bearing ring in the bearing seat occurs outside the region in which rolling elements of the roller bearing are disposed and revolve. There is no compression of the bearing ring by the bearing seat in the vicinity of the rolling elements; the bearing seat into which the roller bearing is pressed does not compress a rolling region of the roller bearing. This has the advantage that a bearing play of the roller bearing is not influenced by the compression of the bearing seat into which the roller bearing is pressed, which permits a more closely toleranced bearing play. This has the advantage of a reduced running noise of the roller bearing, a more precise support of a shaft of the cam of the piston pump, and a reduced wear and consequently a longer service life of the roller bearing.

Advantageous embodiments and modifications of the invention disclosed in the main claim are the subject of the dependent claims.

The invention can in principle be used in all types of roller bearings, i.e. even in ball bearings, which is why claim 1 is directed toward roller bearings in general. Since ball bearings, in comparison to roller bearings or needle bearings, have a relatively solid and stable outer bearing ring, the bearing play in them is less influenced by the compression of the bearing seat. In addition, ball bearings have an inner bearing ring that is not usually present in roller bearings, especially not in needle bearings. The inner bearing ring of ball bearings reduces the influence of the diameter tolerance of a shaft on the bearing play. The influence of the compression on the bearing by the bearing seat is therefore lower in ball bearings than in roller bearings and needle bearings; the invention is therefore particularly advantageous in roller bearings and needle bearings (claim 2).

According to claim 3, the extension of the bearing ring is disposed coaxial to the roller bearing. As a result, the bearing seat in the pump housing is also disposed coaxial to the shaft of the cam, to a possible additional bearing seat, and/or to the motor shaft of the pump motor, which simplifies the manufacture of the bearing seat and the insertion and press-fitting of the roller bearing into the bearing seat.

According to claim 4, the end face of the bearing ring is closed on the side of its extension, i.e. the roller bearing is closed on one side and consequently is protected from the penetration of dirt. This has the advantage that the roller bearing can be inserted into a stepped through bore in the pump housing and that the bore is closed at the end oriented away from the pump motor by the bearing ring that is closed at the end face, and the pump is therefore protected against the penetration of dirt. This is advantageous since it is easier to produce a through bore than it is to produce a blind bore.

According to claim 5, the extension is of one piece with the bearing ring. This has the advantage of permitting the roller bearing to be inexpensively produced since an additional part is not needed. According to claim 6, the roller bearing according to the invention has a bearing bracket into which the roller bearing is inserted and which has the lateral extension of the roller bearing. This embodiment of the invention has the advantage that a commercially available standard bearing can be used. In fact, in this embodiment of the invention, the bearing bracket exerts a compression on the bearing ring of the roller bearing inserted into the bearing bracket, in the vicinity of the rolling elements, but a wall thickness of the rolling elements can be slight or the bearing bracket can be embodied as elastic in the radial direction by being slit in the vicinity of the roller bearing so that the influence of the compression of the bearing bracket on the bearing play of the roller bearing is less than when the roller bearing is pressed directly into the bearing seat of the pump housing.

Claim 7 provides a noise-damping material, which is applied to the bearing ring in the vicinity of the rolling bodies. The noise-damping material prevents the transmission of structure-borne noise from the bearing ring to the pump housing and thus reduces perceptible running noise of the roller bearing. In addition, the noise-damping material damps oscillations of the bearing ring and therefore counteracts noise production. Since the noise-damping material is not disposed on the extension of the roller bearing and is therefore not disposed in the bearing seat, the seat of the roller bearing in the bearing seat is not influenced by noise damping material.

The roller bearing according to the invention is particularly provided for rotatably supporting a cam of a piston pump in its housing, but is not limited to this application since the roller bearing according to the invention can also be used other supports. The collateral claims 8 and 10 are directed toward a piston pump or a pump unit with a pump motor and a piston pump, wherein a cam, which serves to drive a pump piston to execute a stroke motion, is rotatably supported in a pump housing by means of the roller bearing according to the invention.

The piston pump according to the invention is particularly provided as a pump in a brake system of a vehicle and is used to control the pressure in wheel brake cylinders. Depending on the type of brake system, these brake systems are referred to by the abbreviations ABS, TCS, ESP, or EHB. In the brake system, the pump is used, for example, to return brake fluid from one or more of wheel brake cylinders to a master cylinder (ABS) and/or for supplying brake fluid from a reservoir into one or more of wheel brake cylinders (TCS, ESP, or EHB). The pump is required, for example, in a brake system with a wheel slip regulation (ABS or TCS) and/or in a brake system used as a steering aid (ESP) and/or in an electrohydraulic brake system (EHB). Wheel slip regulation (ABS or TCS) can, for example, prevent the wheels of the vehicle from locking when powerful pressure is exerted on the brake pedal during a braking maneuver (ABS) and/or can prevent the driven wheels of a vehicle from spinning when powerful pressure is exerted on the accelerator pedal. In a brake system used as a steering aid (ESP), a brake pressure is built up in one or more wheel brake cylinders, independent of an actuation of the brake pedal or accelerator pedal, in order, for example, to prevent the vehicle from swerving out from the path desired by the driver. The pump can also be used in an electrohydraulic brake system (EHB) in which the pump supplies brake fluid to the wheel brake cylinder(s) when an electric brake pedal sensor detects an actuation of the brake pedal or in which the pump is used to fill a reservoir of the brake system.

### DRAWINGS

The invention will be explained in detail below in conjunction with preferably selected exemplary embodiments shown in the drawings.

FIG. 1 shows an axial section through a pump unit with a piston pump and a roller bearing according to the invention; and

FIGS. 2 to 4 show show modified embodiments of the pump unit from FIG. 1.

### DESCRIPTION OF THE EXEMPLARY EMBODIMENTS

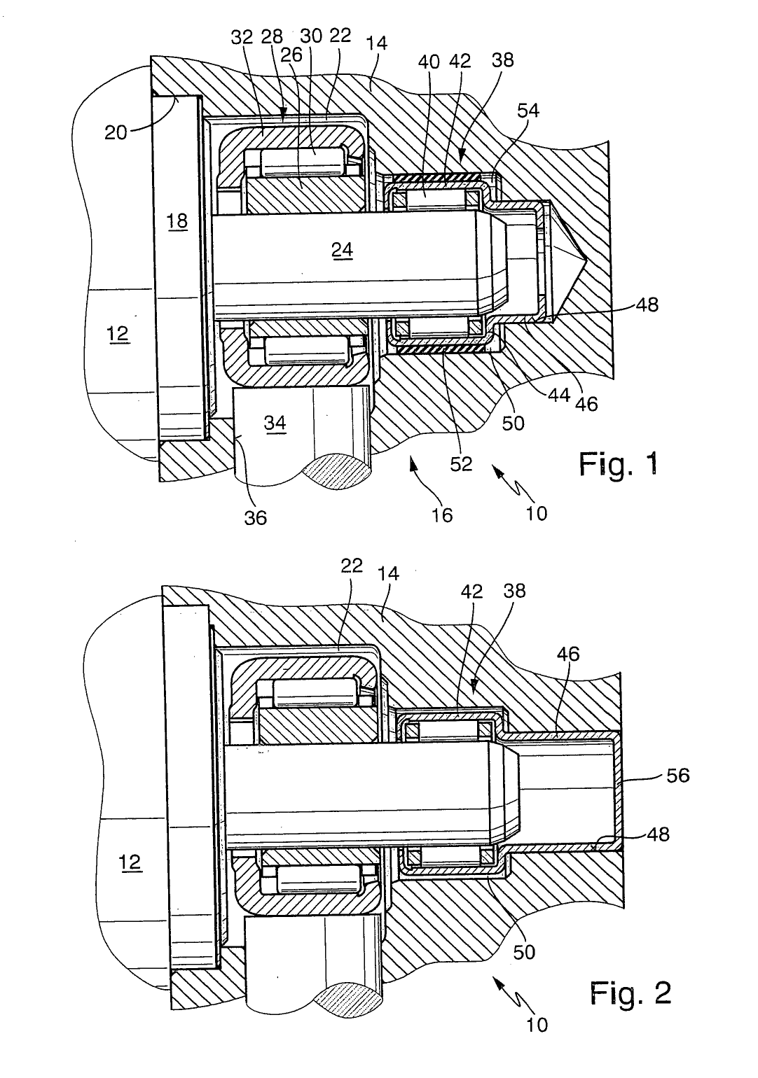

The pump unit 10 according to the invention shown in FIG. 1 has an electric motor as a pump motor 12, which is flange-mounted to a pump housing 14 of a piston pump 16. For the sake of clarity, only a small fraction of the housing of the pump motor 12 is shown; the pump motor 12 has a diameter many times greater than the bearing depicted in the drawing. The pump motor 12 has a centering collar 18 with which it is inserted in a precisely fitting manner into a countersink 20 at the mouth of a stepped bore 22, which is let into the pump housing 14.

The pump housing 14 is part of a hydraulic block 14 of an otherwise not shown slip-control device of a hydraulic vehicle brake system. The hydraulic block 14 is comprised, for example, of an aluminum diecasting alloy. Only a fraction of the hydraulic block 14 in the vicinity of the piston pump 16 is shown in the drawing, i.e. the part that forms the pump housing 14. The stepped bore 22 in the pump housing 14 is embodied as a blind bore; it ends closed on a side oriented away from the pump motor 12. For example, the pump motor 12 is screwed to the pump housing 14 by means of screws that are not shown in the drawing.

A motor shaft 24 of the pump motor 12 protrudes into the stepped bore 22 in the pump housing 14. A cam 26 is non-rotatably pressed onto the motor shaft 24 close to the motor. The cam 26 is embodied as a cylindrical sleeve with a cylindrical through bore, wherein the bore is disposed axially parallel and eccentric to an outer circumference of the cam 26. The motor shaft 24 onto which the cam 26 is non-rotatably pressed thus simultaneously constitutes a shaft of the cam 26.

A first needle bearing 28 with needles 30 and a bearing ring 32 is placed onto the cam 26, wherein the needles 30 roll along the cam 26 when the motor shaft 24 rotates. Due to the eccentricity of the cam 26, the bearing ring 32 moves along a circular path.

Radial to the motor shaft 24, a pump piston 34 of the piston pump 16 is inserted into a bore 36 in the pump housing 14. The pump piston 34 is guided so that it can move axially in the bore 36, wherein the axial direction and thus the movement direction of the pump piston 34 are disposed radial to the motor shaft 24. A piston return spring that is not visible in the drawing pushes the pump piston 34 from the outside against the bearing ring 32 of the first needle bearing 28. When the motor shaft 24 rotates, the cam 26 drives the piston 34 to execute a stroke motion, which causes the piston pump 16 to deliver brake fluid in an intrinsically known fashion. The piston return spring that is not visible in the drawing is disposed at an end oriented away from the cam 26 and is embodied as a helical compression spring, which presses against an end face of the pump piston 34 oriented away from the cam 26.

On an end oriented away from the pump motor 12, the motor shaft 24 protrudes beyond the cam 26; on a side of the cam 26 oriented away from the pump motor 12, the motor shaft 24 is supported by means of a second needle bearing 38 according to the invention so that it can rotate in the pump housing 14. The second needle bearing 38 has needles 40, which roll along the motor shaft 24 when it rotates, and a bearing ring 42, which encompasses the needles 40 and in which the needles 40 roll when the motor shaft 24 rotates. The bearing ring 42 is a sleeve-shaped part, which, at an end oriented away from the pump motor 12 and the cam 26, tapers by means of an annular step 44 down to a smaller diameter extension 46 with which the bearing ring 42 is pressed into a bearing seat 48 in the pump housing 14. The bearing seat 48 is constituted by a section of the stepped bore 22 in the pump housing 14. In the vicinity of the needles 40 of the second needle bearing 38, there is an annular gap 50 between the pump housing 14 and the bearing ring 42 so that the bearing ring 42 is not compressed in the vicinity of the needles 40. The bearing ring 42 of the second needle bearing 38 is only compressed in the vicinity of the extension 46, which is pressed into the bearing seat 48. A bearing play of the second needle bearing 38 is therefore not influenced by the compression of the bearing ring 42 in the bearing seat 48.

The annular gap 50 encompassing the bearing ring 42 of the second needle bearing 38 in the vicinity of the needles 40 can be empty. In the exemplary embodiment shown, the annular gap 50 is filled with an elastomer 52 that serves as a noise-damping material. The elastomer 52 is vulcanized onto the outside of the bearing ring 42 in the vicinity of the needles 40. There is an axial gap 54 between the annular step 44 of the bearing ring 42 and the pump housing 14.

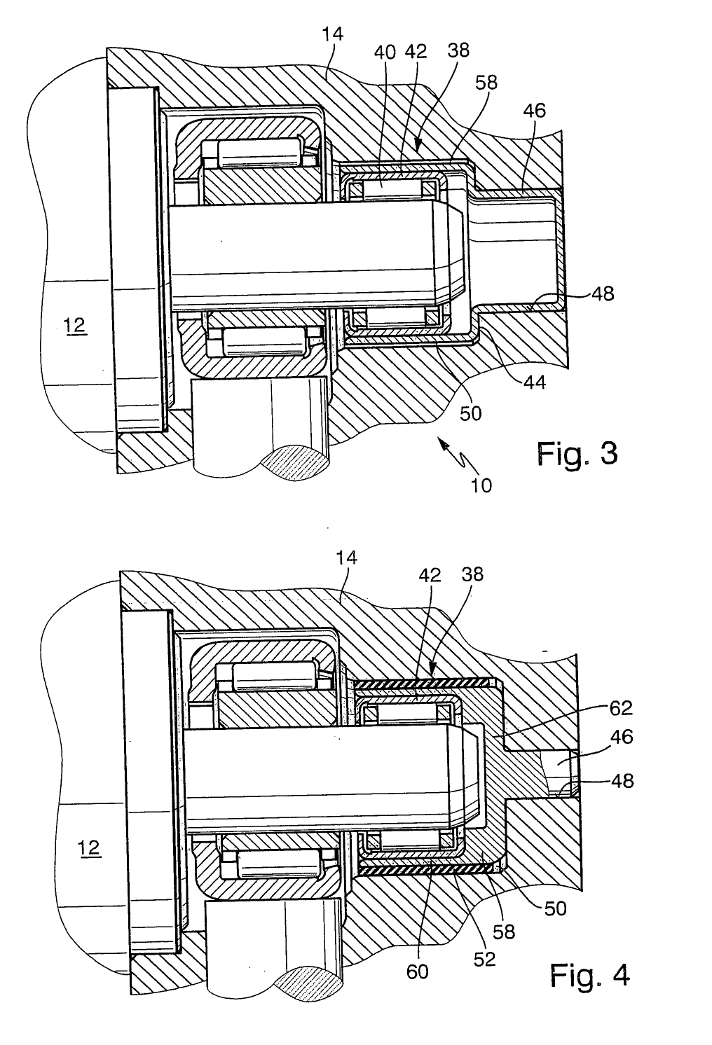

In the description of FIGS. 2 to 4 below, the discussion will essentially center solely on the differences from FIG. 1 and otherwise, reference is made to the corresponding descriptions in conjunction with FIG. 1 in order to avoid repetition. Parts that are the same are labeled with the same reference numerals. By contrast to FIG. 1, the second needle bearing 38 of the pump unit 10 according to the invention shown in FIG. 2 is embodied as closed on one side, i.e. on the side oriented away from the pump motor 12. On the side oriented away from the pump motor 12, the extension 46 of the sleeve-shaped bearing ring 42 is closed by an end wall 56, which is of one piece with the extension 46. As a result, the stepped bore 22 in the pump housing 14 can be produced as a through bore. After the second needle bearing 38 is pressed with the extension 46 into the bearing seat 48, the end wall 56 of the extension 46 closes the stepped bore 22 in the pump housing 14 and thus prevents the penetration of dirt and possibly the escape of lubricants or hydraulic fluid.

In addition, the noise-damping material has been eliminated from the annular gap 50 between the bearing ring 42 and the pump housing 14. The annular gap 50 is empty.

In the embodiment of the invention shown in FIG. 3, the second needle bearing 38 is inserted into a bearing bracket 58. The second needle bearing 38 can be fixed in the bearing bracket 58 by means of a compression between the bearing bracket 58 and the bearing ring 42. Another possibility is to fix the bearing ring 42 in the bearing bracket 58, for example by means of an adhesive or a so-called screw retention lacquer. The bearing bracket 58 is a sleeve-shaped deep-drawn part that tapers by means of an annular step 44 down to a coaxial extension 46. The extension 46 of the bearing bracket 58 is pressed into the bearing seat 48 in the pump housing 14. The extension 46 of the bearing bracket 58 also constitutes the extension 46 of the second needle bearing 38 according to the invention. In this embodiment of the invention, too, the compression between the needle bearing 38 and the bearing seat 48 in the pump housing 14 occurs laterally outside the region in which the needles 40 of the second needle bearing 38 are disposed and revolve.

In the exemplary embodiment of the invention shown in FIG. 3, a compression also occurs between the bearing bracket 58 and the bearing ring 42 of the needle bearing 38, but due to the slight wall thickness of the bearing bracket 58, the influence of this compression on the bearing play of the needle bearing 38 is less than in the vicinity of its needles 40 in a conventional pressing of the needle bearing 38 into a bearing seat. The advantage of this embodiment of the invention is the ability to use a conventional standard needle bearing. In the vicinity of the needles 40, there is an annular gap 50 between the bearing bracket 58 and the pump housing 14 so that the pump housing 14 does not exert any compression on the needle bearing 38 in the vicinity of the needles 40.

In the exemplary embodiment of the invention shown in FIG. 4, the second needle bearing 38 has a bearing bracket 58 like the one in FIG. 3, into which the needle bearing 38 is inserted. The bearing bracket 58 in FIG. 4, however, is not embodied as a deep-drawn part, but as a shaped part, for example produced by means of cold forming. It is also possible to produce the bearing bracket 58 by means of cutting machining. The bearing bracket 58 in FIG. 4 has a cup-like, thin-walled section 60 into which the needle bearing 38 is inserted. The section 60 has an end wall 62 that is of one piece with it, from which a pin extends coaxially outward, which constitutes the extension 46 of the second needle bearing 38 according to the invention. The pin 46 of the bearing bracket 58 of the second needle bearing 38 is inserted into the bearing seat 48 in the pump housing 14.

In the exemplary embodiment of the invention shown in FIG. 4, as in FIG. 1, an elastomer 52 serving as a noise-damping material, is vulcanized onto the outer circumference of the cup-shaped section 60 of the bearing bracket 58. The elastomer 52 fills the annular gap 50 between the bearing bracket 58 and the pump housing 14.

In order to reduce a possible compression between the bearing bracket 58 and the bearing ring 42 of the second needle bearing 38 inserted into the bearing bracket 58 in FIGS. 3 and 4, the section 60 of the bearing bracket 58 into which the needle bearing 38 is inserted can be provided with longitudinal or oblique slits (not shown).

1. A roller bearing with a bearing ring and with rolling elements, characterized in that the bearing ring (42) has a lateral extension (46) with which it can be pressed into a bearing seat (48).

2. The roller bearing according to claim 1, characterized in that the roller bearing (38) is a roller bearing or a needle bearing (38) and that the rolling elements (40) are rollers or needles (40).

3. The roller bearing according to claim 1, characterized in that the extension (46) is coaxial to the roller bearing (38).

4. The roller bearing according to claim 1, characterized in that the bearing ring (42) is closed on the side of its extension (46).

5. The roller bearing according to claim 1, characterized in that the extension (46) is of one piece with the bearing ring (42).

6. The roller bearing according to claim 1, characterized in that the roller bearing (38) has a bearing bracket (58) into which the roller bearing (38) is inserted and that the bearing bracket (58) has the lateral extension (46) of the roller bearing (38).

7. The roller bearing according to claim 1, characterized in that the bearing ring (42) has a noise-damping material (52) in the vicinity of the rolling elements (40).

8. A piston pump with a pump housing, having a cam that is supported with a roller bearing so that it can rotate in the pump housing, wherein the roller bearing has a bearing ring with which it is pressed into a bearing seat in the pump housing and has rolling elements, and having a pump piston that is contained so that it can move axially in the pump housing and can be driven to execute a stroke motion in the axial direction through a rotary drive of the cam, characterized in that the bearing ring (42) of the roller bearing (38) has a lateral extension (46) with which the bearing ring (42) is pressed into the bearing seat (48) in the pump housing (14).

9. The piston pump according to claim 8, characterized in that the roller bearing (38) is disposed on a side of the cam (26) oriented away from a drive mechanism (12) of the piston pump (16).

10. A pump unit having a pump motor, having a piston pump that has a pump housing and is connected to the pump motor, wherein the piston pump has a cam that can be driven in rotary fashion by the pump motor and is supported with a roller bearing so that it can rotate in the pump housing, wherein the roller bearing has a bearing ring with which it is pressed into a bearing seat in the pump housing and has rolling elements, and having a pump piston that is contained so that it can move in the pump housing and can be driven to execute a stroke motion through a rotary drive of the cam, characterized in that the bearing ring (42) of the roller bearing (38) has a lateral extension (46) with which the bearing ring (42) is pressed into the bearing seat (48) in the pump housing (14).

11. The pump unit according to claim 10, characterized in that the roller bearing (38) is disposed on a side of the cam (26) oriented away from the pump motor (12).

12. The pump unit according to claim 10, characterized in that the cam (26) is non-rotatably connected to a motor shaft (24) of the pump motor (12).
